(19) United States
(12) Patent Application Publication
(10) Pub. No.: US 2009/0216456 A1
(43) Pub. Date: Aug. 27, 2009

(54) ANALYZING DYNAMIC PERFORMANCE OF RESERVOIR DEVELOPMENT SYSTEM BASED ON THERMAL TRANSIENT DATA

(75) Inventor: Bobby Dale Poe, JR., Houston, TX (US)

Correspondence Address: Schlumberger Technology Corporation, P. O. Box 425045, Cambridge, MA, 02142, US

(73) Assignee: SCHLUMBERGER TECHNOLOGY CORPORATION, Cambridge, MA (US)

(21) Appl. No.: 12/038,270

(22) Filed: Feb. 27, 2008

(51) Int. Cl. E21B 47/06; G01V 9/00

(52) U.S. Cl. 702/11; 73/152.12

(57) ABSTRACT

A solution for analyzing a performance of a reservoir development system is disclosed. A method may include: receiving thermal transient data for the reservoir development system; determining a thermal parameter of the reservoir development system based on the thermal transient data; and analyzing a thermal transient performance of the reservoir development system based on the thermal parameter.

### FIELD OF THE INVENTION

The disclosure relates in general to reservoir development, and more particularly to analyzing a dynamic performance of a reservoir development system based on thermal transient data.

### BACKGROUND OF THE INVENTION

Hydraulic properties of a reservoir development system need to be constantly monitored or simulated for the life span of an oil or gas reservoir. A reservoir development system generally includes a wellbore and associated fluids and the earth formation and associated fluids. For example, permeability is a measure of the ability of a material to transmit fluids, which is of great importance in determining the dynamic flow characteristics of hydrocarbons in oil and/or gas reservoirs. Earth formations are complex and heterogeneous such that the permeability is not distributed uniformly, which requires substantial efforts in obtaining and analyzing data to determine the permeability distribution. Due to various technology and cost/efficiency limitations, it can be relatively difficult to obtain the data required for determining a hydraulic property and/or for conducting a pressure transient performance analysis of a reservoir development system.

Furthermore, in the current practice in the petroleum industry, no solution exists to quantitatively evaluate the thermal transient behavior of production or injection oil and/or gas wells. Most of the reported research has been focused only on steady state analyses that are used to estimate the relative inflow into a wellbore from the completed intervals of the wellbore. The thermal measurement data has not been used to evaluate a thermal transient performance of a reservoir development system.

In addition, the existing solutions using thermal measurements are only applicable for vertical unfractured wells and no solution has been provided for deviated or slanted, vertically fractured, horizontal, or complex branched wells. Moreover, the existing solutions using thermal measurements are not comparable to that of fluid flow testing/pressure transient solutions in, for example, scope, thoroughness and/or complexity, such that the existing thermal solutions do not provide sufficient information regarding the dynamic behavior/performance of a well and the respective earth formation.

### SUMMARY OF THE INVENTION

In one embodiment, there is a method for analyzing performance of a reservoir development system. In this embodiment, the method comprises: receiving thermal transient data for the reservoir development system; determining a thermal parameter of the reservoir development system based on the thermal transient data; and analyzing a thermal transient performance of the reservoir development system based on the thermal parameter.

In a second embodiment, there is a system for analyzing performance of a reservoir development system. In this embodiment, the system comprises: means for receiving thermal transient data for the reservoir development system; means for determining a thermal parameter of the reservoir development system based on the thermal transient data; and means for analyzing a thermal transient performance of the reservoir development system based on the thermal parameter.

In a third embodiment, there is a computer program product for analyzing performance of a reservoir development system. In this embodiment, the computer program product comprises computer usable program code stored in a computer readable medium which, when executed by a computer system, enables the computer system to: receive thermal transient data for the reservoir development system; determine a thermal parameter of the reservoir development system based on the thermal transient data; and analyze a thermal transient performance of the reservoir development system based on the thermal parameter.

In a fourth embodiment, there is a method of providing a system for analyzing performance of a reservoir development system. In this embodiment, the method comprises at least one of creating, maintaining, deploying and supporting a computer infrastructure operable to: receive thermal transient data for the reservoir development system; determine a thermal parameter of the reservoir development system based on the thermal transient data; and analyze the thermal transient performance of the reservoir development system based on the thermal parameter.

In a fifth embodiment, there is a method for conducting a type curve matching analysis of a thermal transient response of a reservoir development system. In this embodiment, the method comprises: constructing a graphical dimensionless thermal transient type curve set, the type curve set including at least one of: a dimensionless wellbore temperature (T_{wD}) or a product of a dimensionless wellbore thermal storage normalized Fourier time and a derivative of the dimensionless wellbore temperature with respect to the dimensionless Fourier time [(t_{DFo}/C_{D}T)*dT_{wD}/d(t_{DFo}/C_{DT})] as a function of the dimensionless Fourier time divided by a dimensionless wellbore thermal storage (t_{DFo}/C_{DT}); and outputting the type curve set for conducting the type curve matching analysis.

Other aspects and features of the present invention, as solely defined by the claims, and additional advantages of the invention will become apparent to those skilled in the art upon reference to the following non-limited detailed description taken in conjunction with the provided figures.

### BRIEF DESCRIPTION OF THE DRAWINGS

The disclosure is illustrated by way of example and is not intended to be limited by the figures of the accompanying drawings in which like references indicate similar elements and in which:

FIG. 1 shows schematically a system according to embodiments of the disclosure.

FIG. 2 shows a flow diagram of the operation of a reservoir performance analysis system.

FIG. 3 shows an example thermal transient type curve set.

FIG. 4 shows shut-in wellbore pressure and temperature response data of an example reservoir dynamic testing case.

FIG. 5 shows a pressure transient diagnostic plot for the shut-in transient data of FIG. 4.

FIG. 6 shows a thermal transient diagnostic plot for the shut-in transient data of FIG. 4.

FIG. 7 shows a pressure-transient type curve matching analysis of the shut-in pressure transient response data of FIG. 4.

FIG. 8 shows a thermal-transient type curve matching analysis of the thermal transient response data of FIG. 4 using the type curve set of FIG. 3.

FIG. 9 shows an infinite-acting thermal flow analysis.

It is noted that the drawings are not necessarily to scale.

### DETAILED DESCRIPTION OF THE DISCLOSURE

Advantages and features of the present invention may be understood more readily by reference to the following detailed description of illustrative embodiments and the accompanying drawings. The present invention may, however, be embodied in many different forms and should not be construed as being limited to the embodiments set forth herein. Rather, these embodiments are provided so that this disclosure will fully convey the concept of the invention to those skilled in the art, and the present invention will only be defined by the appended claims. Like reference numerals refer to like elements throughout the specification.

### 1. System Overview

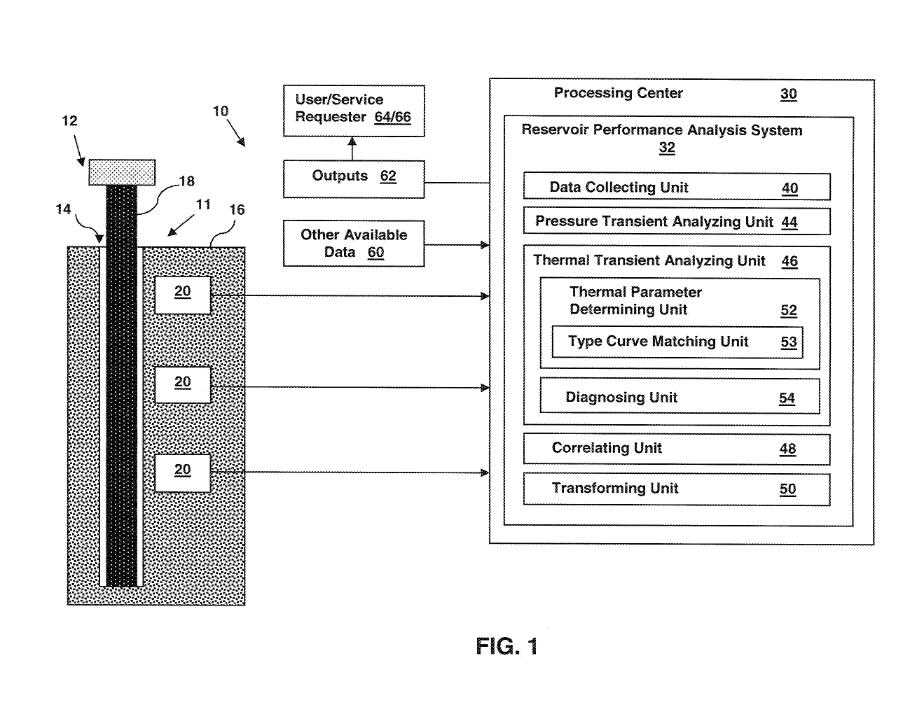

Referring to FIG. 1, a schematic diagram of an illustrative system 10 for analyzing performance of a reservoir 11 development system 12 is shown. Reservoir development system 12 includes wellbore 14 and associated fluids, earth formation 16 and associated fluids, and a production and completion system 18 including, but not limited to, a fluid conduit in wellbore 14 which may include the casing, tubing, and completion accessories such as perforations, gravel pack completions, screens, liners, and proppants. Although shown as a vertical wellbore, wellbore 14 may be any type of wellbore, such as a fully or partially penetrating vertical or slanted wellbore, vertically or horizontally fractured wellbores, and any configuration of horizontal, multi-branched, or undulating wellbores. Reservoir 11 may be any type of reservoir such as, but not limited to, an oil reservoir, a natural gas reservoir, a coal reservoir, or an underground water reservoir.

System 10 includes at least one measurement device 20 positioned along with reservoir development system 12 to measure thermal transient data and/or pressure transient data thereof. Any solution may be used to implement measurement device 20, such as optical fiber, laser source/detector, and packer and probe. In this disclosure, “any solution” refers to any now known or later developed solution to achieve a goal. FIG. 1 shows that measurement devices 20 are positioned in earth formation 16. Measurement devices 20 may also be located at other positions such as within/along wellbore 14 and/or production and completion system 18. Measurement devices 20 communicate the measurement results (data) to a processing center 30 using any communication solution.

Processing center 30 may include a reservoir performance analysis system 32. Reservoir performance analysis system 32 includes a data collecting unit 40, a pressure transient analyzing unit 44, a thermal transient analyzing unit 46, a correlating unit 48, and a transforming unit 50. Thermal transient analyzing unit 46 includes a thermal parameter determining unit 52 including a type curve matching unit 53, and a diagnosing unit 54. Components of processing center 30 and/or reservoir performance analysis system 32 may be located at different locations or may be located at the same location.

According to an embodiment, processing center 30 may be implemented by a computer system. The computer system can comprise any general purpose computing article of manufacture capable of executing computer program code installed thereon to perform the process(es) described herein. The computer system can also comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

In addition to the data communicated from measurement device(s) 20, processing center 30 and/or reservoir performance analysis system 32 may also collect other available data 60 such as available thermal transient performance analysis results and available pressure transient performance analysis results.

Outputs 62 of processing center 30 may be communicated to a user 64 or a service requester 66. For example, outputs 62 may include the analysis results of reservoir performance analysis system 32.

The operation of system 10 and reservoir performance analysis system 32 is described herein in detail.

### 2. Operational Methodology

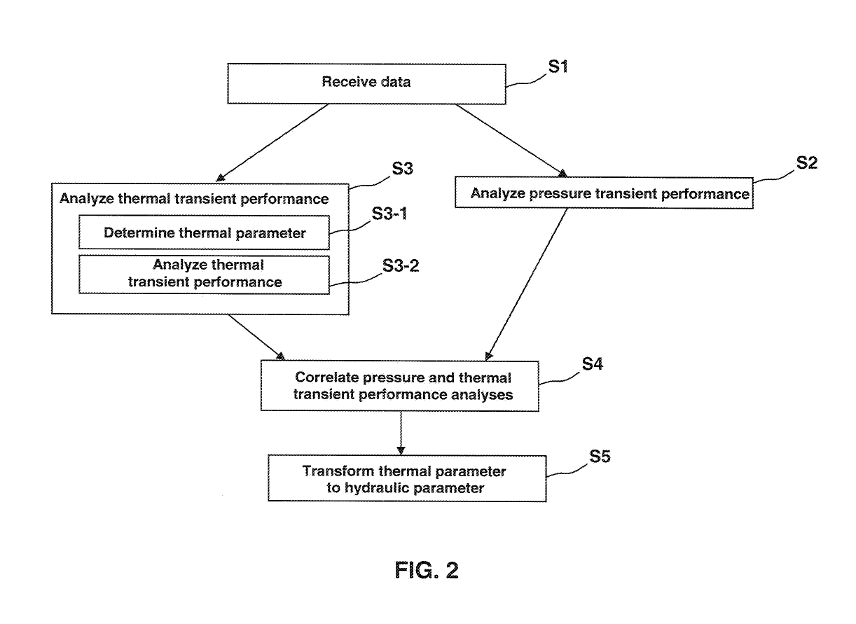

FIG. 2 shows embodiments of the operation of reservoir performance analysis system 32. Referring to FIGS. 1-2, collectively, in process S1, data collecting unit 40 collects dynamic performance testing data regarding reservoir development system 12. Dynamic performance testing data may include thermal transient data and/or pressure transient data. Thermal transient data refers to data related to a thermal transient performance of reservoir development system 12; and pressure transient data refers to data related to a pressure transient performance of reservoir development system 12. For example, distributed temperature sensing (DTS) data may be collected for thermal transient performance analysis. In addition, data collecting unit 40 may also collect other available data 60 such as results of a pressure transient performance analysis conducted for the same reservoir development system 12.

In process S2, when pressure transient data is available, e.g., collected by data collecting unit 40 in process S1, pressure transient analyzing unit 44 analyzes the pressure transient performance of reservoir development system 12. Any solution may be used in the pressure transient performance analysis in process S2. For example, quantitative diagnostic graphic (plot) analysis and/or quantitative type curve matching analysis and/or semilog analysis may be conducted. Type curve matching analysis (in pressure transient performance analysis) is a method for quantifying well and reservoir parameters such as permeability, skin effect, fracture half-length, dual-porosity parameters, and others, by comparing the pressure change and its derivative(s) of the acquired data to reservoir model curve families, called type curves. When a match is found between the data and a type curve, the parameters that characterize the behavior of the respective reservoir model providing a match are thereby determined. Results of the pressure transient performance analysis may include hydraulic diffusivity, a hydraulic steady state skin effect, a pore pressure level, and a relative inflow into wellbore 14 of reservoir development system 12. As further details of the pressure transient performance analysis are not required for the understanding of the current disclosure, no further explanation is provided for clarity. However, process S2 will be further described using an illustrative example herein.

In process S3, thermal transient analyzing unit 46 conducts a thermal transient performance analysis of reservoir development system 12. To this extent, process S3 may include multiple sub-processes. In sub-process S3-1, thermal parameter determining unit 52 determines a thermal parameter of reservoir development system 12 based on the thermal transient data. A thermal parameter may include a thermal property or a relationship between multiple thermal properties. Any thermal parameter may be determined. For example, the thermal parameter may include thermal conductivity (k), thermal diffusivity (α), thermal steady state skin effect (S_{T}), heat capacity (C_{P}), and thermal storage (C_{T}).

Thermal parameter determining unit 52 may determine the quantity of a thermal parameter using mathematical solutions and/or other solutions like type curve matching. For example, the following mathematical solutions may be utilized in determining some illustrative thermal parameters. The mathematical relationship that describes radial thermal diffusion heat transport in a thermally conductive media is given by Equation 1:

$$\frac{{\partial }^{2} T}{\partial {r}^{2}} + \frac{1}{r} \frac{\partial T}{\partial r} = \frac{1}{α} \frac{\partial T}{\partial t} , \qquad ( 1 )$$

where T indicates temperature, r indicates radial distance from the origin of the system (e.g., center of wellbore 14), α indicates thermal diffusivity, and t indicates time. The initial condition of reservoir development system 12 is generally specified as having a uniform temperature throughout,

T=Tᵢ at t=0 for all r (2),

The inner and outer boundary conditions that are applicable for a constant thermal flux withdrawal from the thermally conductive media are given approximately by Equations 3 and 4, respectively:

$${( r \frac{\partial T}{\partial r} )}_{{r}_{w}} = \frac{{Qr}_{w}}{κ} for t > 0 , \qquad ( 3 )$$

and T→Tᵢ as r→∞ for all t (4),

where r_{w} indicates wellbore 14 radius, k indicates thermal conductivity, and Q indicates the thermal flux.

The dimensionless Fourier time (t_{DFo}), dimensionless thermal transient temperature (T_{D}), wellbore dimensionless temperature (T_{wD}), thermal steady state skin effect (S_{T}), and thermal wellbore storage (C_{DT}) may be determined based on Equations 5 through 9, and the dimensionless radial position (r_{D}) in reservoir development system 12 may be determined using Equation 10:

$$\begin{matrix}{t}_{DFo} = \frac{α t}{{r}_{w}^{2}} , & ( 5 ) \\ {T}_{D} = \frac{κ Δ T}{{Qr}_{w}} = \frac{κ ( {T}_{i} - T ( r , t ) )}{{Qr}_{w}} , & ( 6 ) \\ {T}_{wD} = \frac{κ ( {T}_{i} - T ( {r}_{w} , t ) )}{{Qr}_{w}} , & ( 7 ) \\ {S}_{T} = \frac{κ Δ {T}_{s}}{{Qr}_{w}} , & ( 8 ) \\ {C}_{DT} = \frac{{C}_{T}}{2 π {hr}_{w}^{2} {C}_{p} ρ} = \frac{α {C}_{T}}{2 π {hr}_{w}^{2} κ} , & ( 9 ) \\ {r}_{D} = \frac{r}{{r}_{w}} , & ( 10 )\end{matrix}$$

where Cₚ indicates heat capacity (specific heat at a constant pressure), C_{T} indicates thermal storage, Tₛ indicates temperature of formation 16 solid, h indicates reservoir 11 net pay thickness, and ρ indicates the bulk density of formation 16 (solids plus fluids).

Following the equations above, the governing thermal transient relationship, expressed in terms of the dimensionless variables, may be provided using Equation 11:

$$\frac{{\partial }^{2} {T}_{D}}{\partial {r}_{D}^{2}} + \frac{1}{{r}_{D}} \frac{\partial {T}_{D}}{\partial {r}_{D}} = \frac{\partial {T}_{D}}{\partial {t}_{D}} , \qquad ( 11 )$$

where T_{D} indicates dimensionless temperature, r_{D} indicates dimensionless radius, and t_{D} indicates dimensionless time. The initial condition (comparable to that of Equation 2) is given by Equation 12 when expressed in terms of the dimensionless variables:

T_{D}=0 at t_{DFo}=0 for all r_{D} (12),

The inner and outer boundary conditions expressed in terms of the dimensionless variables are given by Equations 13 and 14, respectively:

T_{wD}=1 (13),

where T_{wD} indicates dimensionless wellbore temperature of a variable flow rate history, and

T_{D}→0 as r_{D}→∞ for all t_{D} (14).

The solution of this boundary value problem can be readily obtained using the Laplace transformation technique. The Laplace space solution for the thermal transient problem is given in Equation 15:

$${\tilde{T}}_{D} ( {r}_{D} , s ) = \frac{{K}_{0} ( {r}_{D} \sqrt{s} )}{{s}^{3 / 2} {K}_{1} ( \sqrt{s} )} , \qquad ( 15 )$$

where s represents the Laplace domain parameter, K₀ represents a modified Bessel function of the second kind of order zero, and K₁ represents a modified Bessel function of the second kind of order one. The real space values of this transformed solution (Equation 15) can be readily obtained using a numerical Laplace transform inversion algorithm, such as the one reported by Stehfest in “Numerical Inversion of Laplace Transforms”, Communications of the ACM (January 1970), 13, No. 1, 47-49.

The long-time approximation of Equation 15 is the line source well solution, since as s→0(t_{DF0}→∞), \sqrt{s}K₁(\sqrt{s})→1, which results in

$${\tilde{T}}_{D} ( {r}_{D} , s ) = \frac{1}{s} {K}_{0} ( {r}_{D} \sqrt{s} ) , \qquad ( 16 )$$

The inversion of this result into the real space domain corresponds to the Exponential integral (Ei) solution of a line source well:

$${T}_{D} ( {r}_{D} = 1 , {t}_{DFo} ) = \frac{1}{2} [ - Ei ( \frac{1}{4 {t}_{DFo}} ) ] . \qquad ( 17 )$$

The addition of a steady state thermal skin effect to the Laplace space dimensionless thermal transient solution(s) (Equations 15 to 17) that does not include that effect may be accomplished using equation 18:

$${\tilde{T}}_{wD} ( s ) = {\tilde{T}}_{D} ( {r}_{D} = 1 , s ) + \frac{{S}_{T}}{s} . \qquad ( 18 )$$

The real space equivalent of this relationship (Equation 18) is given by Equation 19, where the steady state thermal skin effect (S_{T}) is essentially an additional near-well dimensionless temperature difference:

T_{wD}(t_{DFo})=T_{D}(r_{D}=1,t_{DFo})+S_{T} (19).

A further simplification of the line source well Exponential integral solution may be obtained by substituting a logarithmic approximation for the Exponential integral, as represented in Equation 20, which is applicable for t_{DFo}>100:

$${T}_{wD} ( {t}_{DFo} ) = \frac{1}{2} [ ln {t}_{DFo} + ln 4 - γ ] + {S}_{T} = \frac{1}{2} [ ln {t}_{DFo} + 0.80907 ] + {S}_{T} , \qquad ( 20 )$$

where S_{T} indicates a near-well steady state thermal skin effect, and γ is Euler's constant (0.5772 . . . ).

Note that the real space line source well solution could also have been derived in a manner analogous to that reported by Polubarinova-Kochina, “Theory of Ground Water Movement”, Translated from Russian by J. M. R. DeWeist, Princeton University Press, Princeton, N.J. (1962) 549, for the pressure transient solution of radial fluid flow in an infinite-acting porous and permeable reservoir. The technique involves a modification of the inner boundary condition (Equation 3), given by Equation 21:

$$\begin{matrix}lim \\ r -> 0\end{matrix} r \frac{\partial T}{\partial r} = \frac{{Qr}_{w}}{κ} for t > 0. \qquad ( 21 )$$

Another issue that may be very important for the development of a useful and practical evaluation technique for a thermal transient performance analysis is the thermal storage of the (reservoir development) system. An example relationship between the sandface thermal flux and the flux at the surface can be expressed approximately in Equation 22:

$$\frac{{q}_{sf}}{q} = 1 - {C}_{DT} \frac{d}{d {t}_{DFo}} {T}_{D} ( {t}_{DFo} , {C}_{DT} , … ) , \qquad ( 22 )$$

where q indicates the flux at the surface, and q_{sf} indicates the sandface thermal flux.

The definition of the dimensionless wellbore thermal storage coefficient has been given in Equation 9 and the effect(s) of this parameter can be readily included in the Laplace space thermal transient solution developed (which originally does not include the effect of this parameter) using Equation 23:

$${\tilde{T}}_{wD} ( s ) = \frac{{\tilde{T}}_{D} ( {r}_{D} = 1 , s )}{1 + {C}_{DT} {s}^{2} {\tilde{T}}_{D} ( {r}_{D} = 1 , s )} . \qquad ( 23 )$$

It should be appreciated that the mathematical equations provided herein are not exclusive, other now known or later developed mathematical equations may also be used by thermal parameter determining unit 52 in sub-process S3-1.

Due to the interactive and/or confounding nature of the relations between and among various parameters (e.g., thermal properties) as shown by the equations herein, thermal property determining unit 52 may utilize type curve matching unit 53 to obtain the quantities of some parameters. For example, type curve matching unit 53 may construct, e.g., a graphical dimensionless thermal transient type curve set including the dimensionless wellbore temperature (T_{wD}) and the product of the dimensionless wellbore thermal storage normalized Fourier time (T_{DFo}/C_{DT}) and the derivative of the wellbore dimensionless temperature with respect to dimensionless Fourier time [(t_{DFo}/C_{DT})*dT_{wD}/d(t_{DFo}/C_{DT})] (commonly referred to simply as the derivative function) as a function of the dimensionless Fourier time divided by the dimensionless wellbore thermal storage (T_{DFo}/C_{DT}) in a manner analogous to that used in pressure transient performance analysis type curve sets. An advantage in normalizing the dimensionless time scale (abscissa) in this manner with the dimensionless wellbore thermal storage (T_{DFo}/C_{DT}) is that it collapses all of the thermal transient solutions to a single log-log unit slope thermal wellbore storage stem for non-negative thermal skin effect values to aid in the graphical matching procedures.

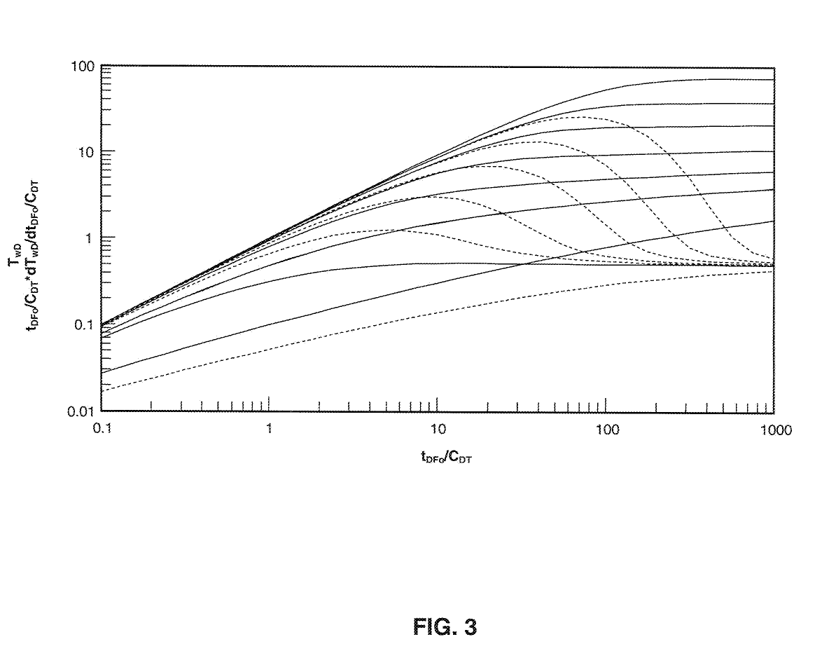

One additional correlating parameter that may be used in the construction of the type curves is the product of the dimensionless wellbore thermal storage and the exponential of twice the steady state thermal skin effect [C_{DT} exp(2S_{T})]. For an illustrative example, FIG. 3 shows a dimensionless thermal transient type curve set constructed in this manner. FIG. 3 presents the dimensionless wellbore temperature curves (in solid lines) and the corresponding derivative curves (in dotted lines). The range in magnitude of the correlating parameter [C_{DT} exp(2S_{T})] for the type curve set(s) presented in FIG. 3 are from 0.01 to 1E60, from bottom to top in each of the T_{wD} and (T_{DFo}/C_{DT})*dT_{wD}/d(t_{DFo}/C_{DT}) curve sets.

Based on the constructed curve type set(s), type curve matching unit 53 may develop type-curve matching analysis procedures that can be used to evaluate, e.g., transient DTS or permanent temperature gauge measurements in order to extract estimates of the formation thermal parameters. Specifically, for example, the received thermal transient data may be matched with the established type curves to determine quantities of certain parameters. Subsequently, the determined quantities may be incorporated into the mathematical equations to determine quantities of other thermal parameter(s) of reservoir development system 12. The type curve matching and the thermal parameter calculation operations are further described herein using an illustrative example.

According to an embodiment, the thermal parameter determination in sub-process S3-1 may be operated on a set of variable flow rate production conditions of reservoir development system 12 to determine the respective thermal parameter(s).

Referring back to FIG. 2, in sub-process S3-2, thermal transient analyzing unit 46 analyzes the thermal transient performance of reservoir development system 12 based on the determined thermal parameter(s). Any analysis may be conducted. For example, thermal transient analyzing unit 46 may analyze a spatial variation of a thermal parameter in at least one of a vertical dimension or a lateral dimension. Thermal transient analyzing unit 46 may also analyze a change in the thermal parameter with respect to time. The thermal parameters of interest may include thermal conductivity, thermal diffusivity, and thermal storage of reservoir development system 12. Moreover, thermal transient analyzing unit 46 may analyze a quantitative relationship between the thermal skin effect temperature difference and a thermal diffusivity. An infinite-acting thermal radial flow analysis (e.g., a Semilog analysis) can also be developed based on the line source well solution provided in Equations 17 or 20.

In addition to quantifying a thermal parameter, the constant rate (flux) drawdown thermal transient type curve solutions presented in FIG. 3 can also be used to evaluate the thermal transient behavior of variable rate thermal transient responses using the principle of superposition-in-time. This also includes the evaluation of shut-in well thermal transient behavior. The convolution integral that applies for determining the effect of a variable flow rate (flux) history on the thermal transient behavior of wellbore 14 correlates with the variable flux thermal transient behavior to the corresponding response(s) that would be obtained for a constant flux solution. The convolution integral may be given using Equation 24:

$${T}_{wD} ( {t}_{D} ) = {\int }_{0}^{{t}_{D}} {q}_{D} ( τ ) \frac{d {T}_{D} ( {t}_{D} - τ )}{d τ} d τ , \qquad ( 24 )$$

where T_{wD}(t_{D}) indicates the wellbore dimensionless temperature of a well with a variable flow rate (flux) history, q_{D} indicates dimensionless flow rate (flux), and dT_{D}/dτ indicates the derivative of the constant flux thermal transient solution with respect to dimensionless time.

In terms of discrete time increments, the thermal convolution integral can be evaluated in the form given approximately by Equation 25:

$${T}_{wD} ( {t}_{Dn} ) = {{\sum }_{{i = 1}_{n > 1}}}^{n - 1} {q}_{Di} [ {T}_{D} ( {t}_{Dn} - {t}_{Di - 1} ) - {T}_{D} ( {t}_{Dn} - {t}_{Di} ) ] + {T}_{D} ( {t}_{Dn} - {t}_{Dn - 1} ) , \qquad ( 25 )$$

where T_{Dn} indicates the dimensionless wellbore temperature at the nₜₕ time level for a variable flow rate history that is approximated using n discrete time intervals.

Note that for the evaluation of shut-in thermal transients where the surface flow rate (flux) during the shut-in transient is equal to zero, the reference flow rate or flux used in the analysis is the flow rate (or flux) of the flowing transient immediately prior to the shut-in transient of interest.

In addition, diagnosing unit 54 may also perform a quantitative graphical (plot) diagnostic analysis. Specialized quantitative diagnostic analyses can be used for the characterization of the transient temperature behavior of reservoir development system 12 using graphical analyses derived from the transient solution of the wellbore temperature. The diagnostic analysis may be based on the determined thermal parameters as derivatives of the DTS or permanent temperature gauge data.

Referring back to FIG. 2, in process S4, correlating unit 48 correlates a result (e.g., a determined thermal parameter) of the thermal transient performance analysis of process S3 (and/or from other available data 60) with a result (e.g., a hydraulic parameter) of the pressure transient performance analysis of process S2 (and/or from other available data 60) to generate a transform model. The transform model represents the correlation and possible transformability between the two types of analyses. The correlating may be conducted in an empirical manner using a pool of multiple data entries, each data entry representing a thermal transient performance analysis result, e.g., a thermal diffusivity, and a corresponding pressure transient performance analysis result, e.g., a hydraulic diffusivity. The pool of data entries, or a sample drawn from the pool, may be analyzed statistically to obtain the correlation, if any, and generate the transform model. Data entries in the pool may be obtained from the analyses of different reservoir development systems or may be obtained from multiple analyses of the same reservoir development system, or any combination thereof. The corresponding pressure transient performance analysis result and thermal transient performance analysis result (i.e., a data entry in the data pool) may also include hydraulic and thermal steady state skin effects, pore pressure level and the directly-measured wellbore temperatures (thermal signature), or relative inflows into wellbore 14 and the associated wellbore thermal signatures (or changes in wellbore temperatures) that correspond to points of formation fluid entry into the wellbore.

In process S5, transforming unit 50 transforms a thermal parameter determined in a thermal transient performance analysis into a hydraulic parameter based on the established transform model. For example, a thermal diffusivity of reservoir development system 12 may be transformed to a hydraulic diffusivity thereof. The thermal parameter may be obtained from process S3 or may be obtained from other available data 60. To this extent, after the transform model is established and/or calibrated, processing center 30 may process available thermal transient performance analysis results to transform them into pressure transient performance analysis results, e.g., hydraulic formation properties of the respective reservoir development system.

### 3. Example Operation

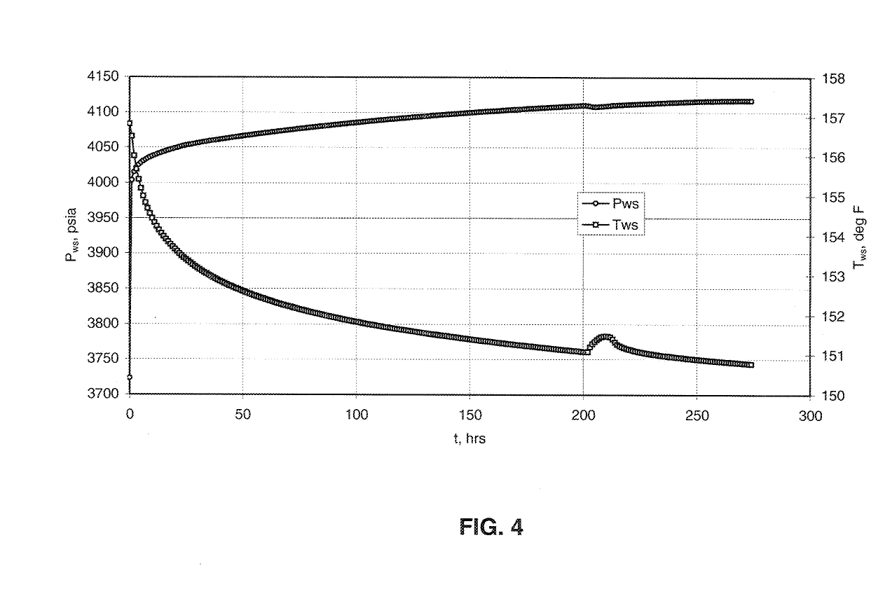

The operation of reservoir performance analysis system 32 is further illustrated using the following illustrative operations on an example reservoir dynamic performance testing case. Assume that an oil well has been produced at 30,000 STB/D for 300 days and then shut-in for two weeks. The formation net pay thickness (h) is equal to 490 feet, with an average effective porosity of 20%, connate water saturation of 10%, and an initial oil saturation of 90%. The wellbore radius for use in the analysis is 0.5 feet and the static average reservoir temperature in this analysis is equal to 158° F. The shut-in wellbore pressure and temperature responses (as may be received in process S1 of FIG. 2) is presented in FIG. 4. The heat capacity (Cₚ) of the reservoir development system is approximately equal to 0.5 BTU/lbₘ−° F. and the bulk density (ρ) of the system is equal to 115 lbₘ/ft³.

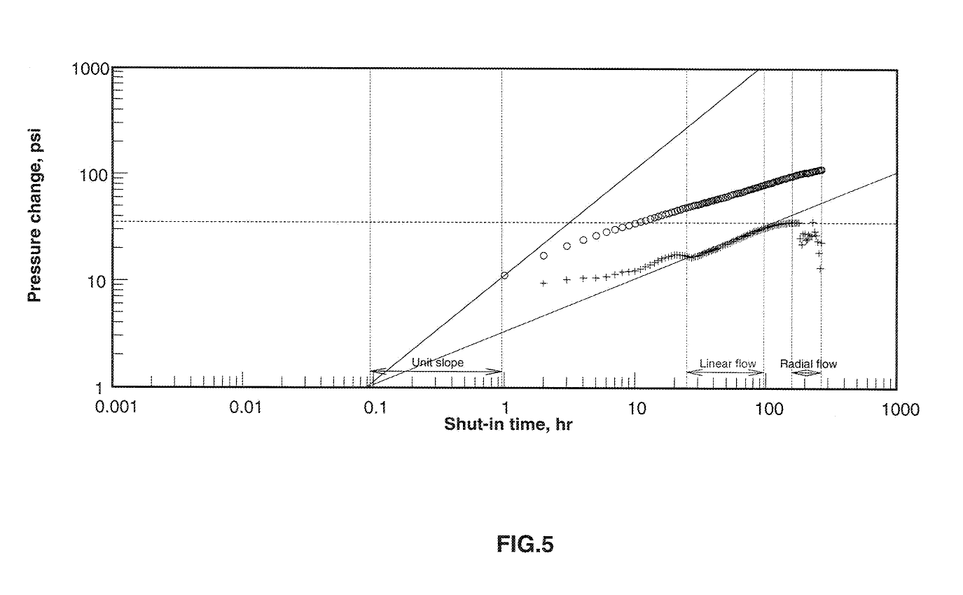

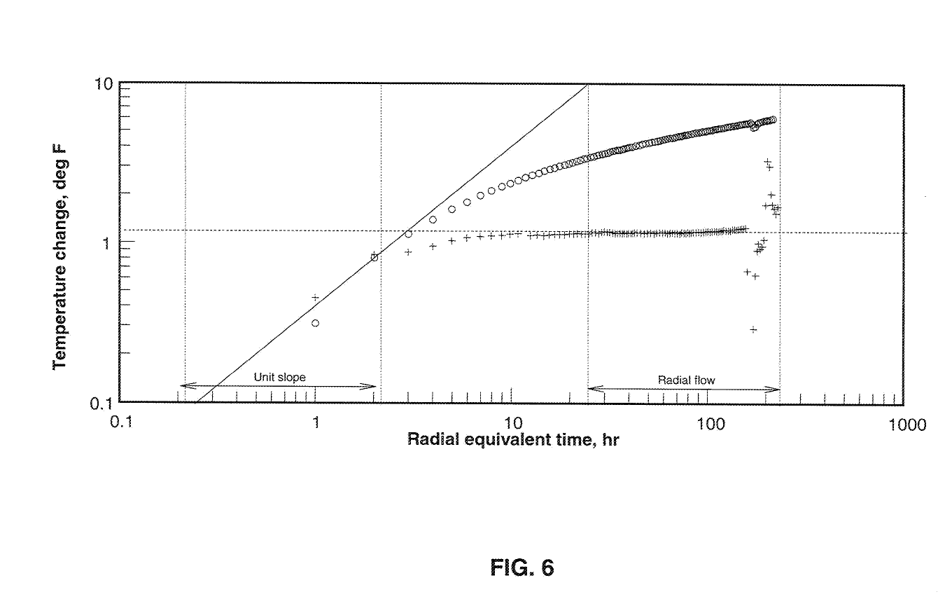

The pressure and thermal transient diagnostic plots (processes S2 and S3-2) for this shut-in transient data (with a correction in pressure for data elevation) are presented in FIGS. 5 and 6, respectively. Note that in the pressure transient diagnostic analysis (FIG. 5), there appears to be three distinctive flow regimes exhibited in the shut-in transient response. The first data point and its corresponding derivative appear to lie on what would be the log-log unit slope linear behavior characteristic of wellbore storage distortion. After approximately 20 hours of shut-in, a well developed linear flow signature appears to be exhibited in the well's pressure transient behavior. Linear flow is characterized by a log-log half slope on both the pressure and derivative responses. Linear flow is also generally a good indication of a negative steady state total skin effect, generally indicating an improved well completion flow efficiency. A conclusion that this linear flow is due to a negative total skin effect (including an improved well completion efficiency) and not a linear flow signature that would correspond to other reservoir configurations (an example of which is channel flow) can be deduced from the fact that the end of the shut-in well transient appears to transition into the infinite-acting pseudo-radial flow regime.

The thermal transient diagnostic analysis (FIG. 6) indicates that there are two distinct thermal transient flow regimes exhibited in the shut-in well response. The first flow regime that is clearly exhibited in the well's thermal transient behavior is wellbore thermal storage, indicated by the log-log unit slope thermal transient behavior for about the first 2 hours of radial equivalent time. This is followed by a transition thermal flow regime that extends until the onset of infinite-acting radial flow behavior, beginning at about 25 hours of radial equivalent time through the end of the shut-in thermal transient response (two weeks).

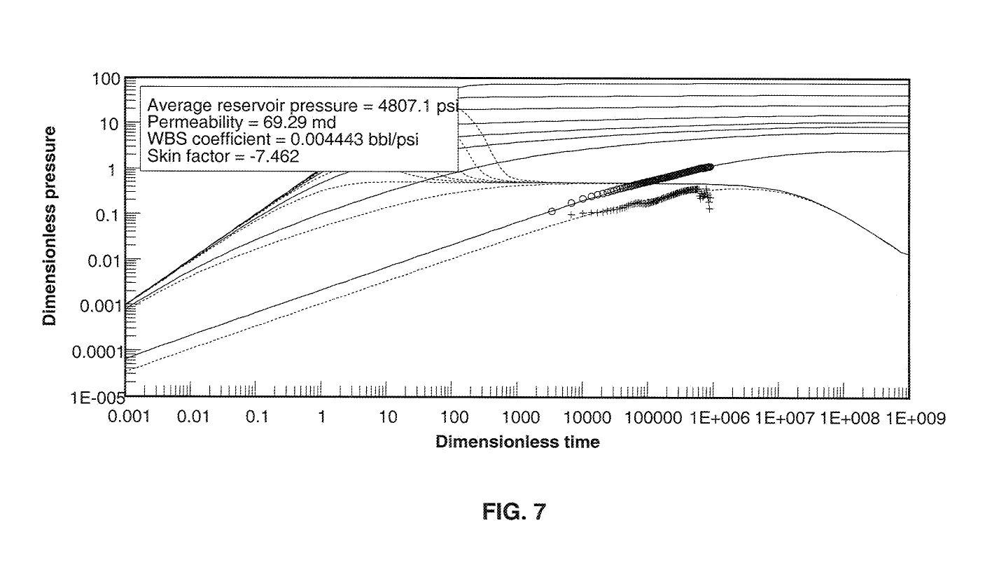

A pressure-transient type curve match (process S2) of the shut-in transient response is presented in FIG. 7. It was determined from the type curve matching procedure that the formation hydraulic conductivity (kh) was equal to 32,210 mD-ft (k=65.5 mD) with a total apparent radial flow steady state skin effect (S) equal to −7.4. The total apparent skin effect includes the skin components of well stimulation/damage, formation/wellbore inclination, partial completion effects, and various other skin effect components. The average reservoir pressure ( p̅ᵣ) computed in the analysis was determined to be slightly higher than 4800 psi.

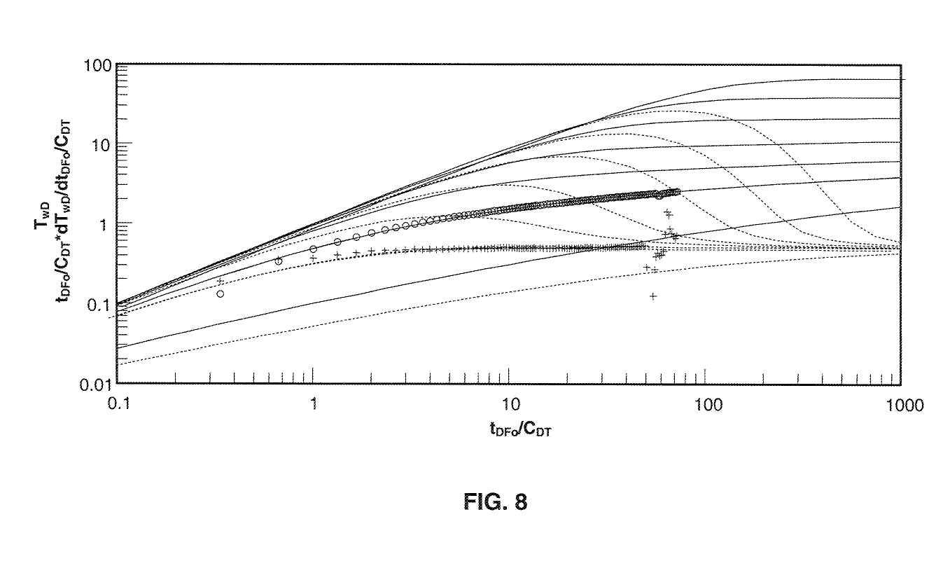

The type curve matching analysis of the thermal transient response (process S3-1) is presented in FIG. 8 using the established (example) type curve sets presented in FIG. 3. The match points obtained in the thermal transient type curve matching analysis are as follows:

[t(/t_{DFo}/C_{DT})]_{M.P.}=2.556 hr

[ΔT/T_{wD}]_{M.P.}=2.264° F.

C_{DT} exp(2S_{T})=0.944

From these match points, the ratio of the thermal storage (C_{T}) to the thermal conductivity (k) is determined approximately by incorporating the match point quantities into Equations 5 and 9 as rearranged below:

$$\frac{{C}_{T}}{κ} = 2 π {h [ \frac{t}{( \frac{{t}_{DFo}}{{C}_{DT}} )} ]}_{MP} , \qquad ( 26 )$$

where subscript MP indicates a matching point, and

$$\frac{{C}_{T}}{κ} = 2 π ( 490 ) ( 2.264 ) = 6970 ft \text{-hr} .$$

The thermal conductivity normalized flux can be determined by rearranging Equation 7 in the form given by Equation 27:

$$\begin{matrix}\frac{Q}{κ} = {[ \frac{Δ T}{{T}_{wD}} ]}_{MP} / {r}_{w} & ( 27 ) \\ and & \\ \frac{Q}{κ} = 2.264 / 0.5 = 4.528 ° F . \text{/} ft . , & \end{matrix}$$

The relationship between the thermal skin effect temperature difference and the thermal diffusivity (Equation 28) is derived from the match points using Equations 5 and 7 through 9:

$$\begin{matrix}Δ {T}_{s} = {\frac{1}{2} [ \frac{Δ T}{{T}_{wD}} ]}_{MP} ln [ \frac{{[ {C}_{DT} exp ( 2 {S}_{T} ) ]}_{MP} {r}_{w}^{2}}{{α [ \frac{t}{[ \frac{{t}_{DFo}}{{C}_{DT}} ]} ]}_{MP}} ] & ( 28 ) \\ and & \\ Δ {T}_{s} = \frac{1}{2} ( 2.264 ) ln [ \frac{0.944 {( 0.5 )}^{2}}{2.556 α} ] = 1.132 ln ( \frac{0.09233}{α} ) ° F . , & \end{matrix}$$

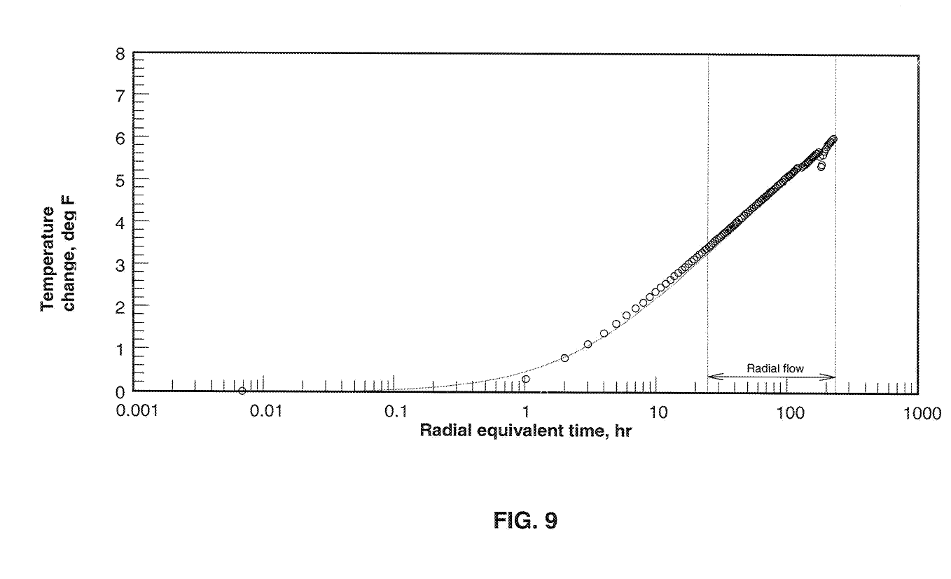

The infinite-acting thermal radial flow analysis (in sub-process S3-2) may be graphically illustrated by FIG. 9.

Process S4 may then be conducted where sufficient empirical data from thermal transient performance analysis and pressure transient performance analysis is available.

### 4. Conclusion

While shown and described herein as a method and system for analyzing a thermal transient performance of a reservoir development system, it is understood that the invention further provides various additional embodiments. For example, in an embodiment, the invention provides a program product stored on a computer-readable medium, which when executed, enables a computer infrastructure to analyze a thermal transient performance of a reservoir development system. To this extent, the computer-readable medium includes program code, such as reservoir performance analysis system 32 (FIG. 1), which implements the process described herein. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, such as memory and/or other storage system, and/or as a data signal traveling over a network (e.g., during a wired/wireless electronic distribution of the program product).

In addition, a method of providing a system for analyzing a thermal transient performance of a reservoir development system can be included. In this case, a computer infrastructure, such as process center 30 (FIG. 1), can be obtained (e.g., created, maintained, supported, having been made available to, etc.) and one or more systems, such as reservoir performance analysis system 32 (FIG. 1), for performing the process described herein can be obtained (e.g., created, purchased, used, modified, etc.) and deployed to the computer infrastructure. To this extent, the deployment of each system can comprise one or more of: (1) installing program code on a computing device, such as processing center 30 (FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

As used herein, it is understood that the terms “program code” and “computer program code” are synonymous and mean any expression, in any language, code or notation, of a set of instructions that cause a computing device having an information processing capability to perform a particular function either directly or after any combination of the following: (a) conversion to another language, code or notation; (b) reproduction in a different material form; and/or (c) decompression. To this extent, program code can be embodied as one or more types of program products, such as an application/software program, component software/a library of functions, an operating system, a basic I/O system/driver for a particular computing and/or I/O device, and the like. Further, it is understood that the terms “component” and “system” are synonymous as used herein and represent any combination of hardware and/or software capable of performing some function(s).

The flowcharts and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While the disclosure has been particularly shown and described with reference to illustrative embodiments thereof, it will be understood by those of ordinary skilled in the art that various changes in form and details may be made therein without departing from the spirit and scope of the present invention as defined by the claims. In addition, those of ordinary skill in the art appreciate that any arrangement which is calculated to achieve the same purpose may be substituted for the specific embodiments shown and that the invention has other applications in other environments.

We claim:

1. A method for analyzing performance of a reservoir development system, the method comprising:
receiving thermal transient data for the reservoir development system;
determining a thermal parameter of the reservoir development system based on the thermal transient data; and
analyzing a thermal transient performance of the reservoir development system based on the thermal parameter.

2. The method of claim 1, wherein the analyzing includes performing a quantitative graphical diagnostic analysis of the reservoir development system.

3. The method of claim 1, wherein the analyzing includes analyzing a variation of the thermal parameter in at least one of a vertical dimension, a lateral dimension, or time.

4. The method of claim 1, wherein the determining includes performing a type curve matching analysis based on the thermal transient data.

5. The method of claim 4, wherein the type curve matching analysis includes constructing a graphical dimensionless thermal transient type curve set including at least one of: a dimensionless wellbore temperature (T_{wD}) or a product of a dimensionless wellbore thermal storage normalized Fourier time and a derivative of the dimensionless wellbore temperature with respect to the dimensionless Fourier time [(t_{DFo}/C_{DT})*dT_{wD}/d(t_{DFo}/C_{DT})] as a function of the dimensionless Fourier time divided by a dimensionless wellbore thermal storage (t_{DFo}/C_{DT}).

6. The method of claim 1, further comprising:
receiving a result of a pressure transient performance analysis of the reservoir development system; and
correlating the result of the pressure transient performance analysis with a result of the thermal transient performance analysis to generate a transform model.

7. The method of claim 6, further comprising transforming a thermal parameter of the reservoir development system into a hydraulic parameter thereof based on the transform model.

8. The method of claim 6, wherein the hydraulic parameter includes at least one of: a hydraulic diffusivity, a hydraulic steady state skin effect, a pore pressure level, or a relative inflow into a wellbore of the reservoir development system.

9. The method of claim 1, wherein determining the thermal parameter includes determining the thermal parameter for a set of variable flow rate production conditions.

10. A system for analyzing performance of a reservoir development system, the system comprising:
means for receiving thermal transient data for the reservoir development system;
means for determining a thermal parameter of the reservoir development system based on the thermal transient data; and
means for analyzing a thermal transient performance of the reservoir development system based on the thermal parameter.

11. The system of claim 10, wherein the analyzing means includes means for conducting a quantitative graphical diagnostic analysis of the reservoir development system.

12. The system of claim 10, wherein the analyzing means analyzes a variation of the thermal parameter in at least one of a vertical dimension, a lateral dimension, or time.

13. The system of claim 10, wherein the determining means includes means for conducting a type curve matching analysis based on the thermal transient data.

14. The system of claim 10, further comprising:
means for correlating a result of a provided pressure transient performance analysis with a result of the thermal transient performance analysis to generate a transform model; and
means for transforming a thermal parameter of the reservoir development system into a hydraulic parameter thereof based on the transform model.

15. The system of claim 14, wherein the hydraulic parameter includes at least one of: a hydraulic diffusivity, a hydraulic steady state skin effect, a pore pressure level, or a relative inflow into a wellbore of the reservoir development system.

16. A computer program product for analyzing performance of a reservoir development system, comprising:
computer usable program code stored in a computer readable medium which, when executed by a computer system, enables the computer system to:
receive thermal transient data for the reservoir development system;
determine a thermal parameter of the reservoir development system based on the thermal transient data; and
analyze a thermal transient performance of the reservoir development system based on the thermal parameter.

17. The program product of claim 16, wherein the program code is further configured to enable the computer system to conduct a quantitative graphical diagnostic analysis of the reservoir development system.

18. The program product of claim 16, wherein the program code is further configured to enable the computer system to analyze a variation of the thermal parameter in at least one of a vertical dimension, a lateral dimension, or time.

19. The program product of claim 16, wherein the program code is configured to enable the computer system to conduct a type curve matching analysis based on the thermal transient data.

20. The program product of claim 16, wherein the program code is further configured to enable the computer system to:
receive a result of a pressure transient performance analysis of the reservoir development system;
correlate the result of the pressure transient performance analysis with a result of the thermal transient performance analysis to generate a transform model; and
transform a thermal parameter of the reservoir development system into a hydraulic parameter thereof based on the transform model.

21. The program product of claim 20, wherein the hydraulic parameter includes at least one of: a hydraulic diffusivity, a hydraulic steady state skin effect, a pore pressure level, or a relative inflow into a wellbore of the reservoir development system.

22. A method of providing a system for analyzing performance of a reservoir development system, the method comprising:
at least one of creating, maintaining, deploying and supporting a computer infrastructure operable to:
receive thermal transient data for the reservoir development system;
determine a thermal parameter of the reservoir development system based on the thermal transient data; and
analyze a thermal transient performance of the reservoir development system based on the thermal parameter.

23. The method of claim 22, wherein the computer infrastructure is further operable to conduct a quantitative graphical diagnostic analysis of the reservoir development system.

24. The method of claim 22, wherein the computer infrastructure is further operable to conduct a type curve matching analysis based on the thermal transient data.

25. A method for conducting a type curve matching analysis of a thermal transient response of a reservoir development system, the method comprising:
constructing a graphical dimensionless thermal transient type curve set, the type curve set including at least one of: a dimensionless wellbore temperature (T_{wD}) or a product of a dimensionless wellbore thermal storage normalized Fourier time and a derivative of the dimensionless wellbore temperature with respect to the dimensionless Fourier time [(t_{DFo}/C_{DT})*dT_{wD}/d(t_{DFo}/C_{DT})] as a function of the dimensionless Fourier time divided by a dimensionless wellbore thermal storage (t_{DFo}/C_{DT}); and
outputting the type curve set for conducting the type curve matching analysis.
